(19) United States
(12) Patent Application Publication
(10) Pub. No.: US 2004/0083923 A1
(43) Pub. Date: May 6, 2004

(54) Single fluid lithographic ink

(76) Inventors: Mark D. Latunski, Morrice, MI (US); Srinivas Uppuluri, Ypsilanti, MI (US); Greg J. Sarnecki, Ann Arbor, MI (US); Barna Szabo, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 10/285,929

(22) Filed: Oct. 31, 2002

(51) Int. Cl. C09D 11/08

(52) U.S. Cl. 106/31.41; 106/31.73

(57) ABSTRACT

The present invention provides single fluid lithographic printing inks that include a continuous phase and a discontinuous emulsified phase. The continuous phase includes a polymer or mixture of polymers having from about 0.25 to about 15 meq/gram of groups capable of hydrogen bonding with the hydrophilic phase, from about 1.0 to about 3.0 meq/gram of one or more members selected from the group consisting of aromatic groups, cyclic aliphatic groups, and combinations thereof, and from about 0.3 to about 3.0 meq/gram of aliphatic hydrocarbon segments, each independently having from about 8 carbon atoms to about 51 carbon atoms. The emulsified phase includes water and/or a liquid polyol. The invention further provides a method of making a single fluid ink composition and a process of printing using the single fluid ink of the invention with improved resistance to toning.

### FIELD OF THE INVENTION

The present invention relates to compositions of lithographic printing inks and lithographic printing methods.

### BACKGROUND OF THE INVENTION

Printing inks generally include one or more vehicles and one or more colorants as principal components. Printing ink vehicles must meet a number of performance requirements that include both requirements related to the printing process, such as suitable consistency and tack for sharp, clean images, suitable length to avoid fly or mist, or proper drying characteristics, and requirements related to the printed image, such as gloss, chemical resistance, durability, or color. In general, ink vehicles include one or more materials such as vegetable oils or fatty acids, resins, and polymers that contribute to the end product properties, and may include other components such as organic solvents, water, rheology modifiers, and so on that may affect body, tack, or drying characteristics.

In lithographic printing, an inked printing plate contacts and transfers an inked image to a rubber blanket, and then the blanket contacts and transfers the image to the surface being printed. Lithographic plates are produced, for example, by treating the image areas of the plate with an oleophilic material and ensuring that the non-image areas are hydrophilic. In a typical lithographic printing process, the plate cylinder first comes in contact with dampening rollers that transfer an aqueous fountain solution to the hydrophilic non-image areas of the plate. The dampened plate then contacts an inking roller, accepting the ink only in the oleophilic image areas. The press operator must continually monitor the printing process to insure that the correct balance of the fountain solution and the ink is maintained so that the ink adheres to the printing areas, but only the printing areas, of the plate in order to produce a sharp, well-defined print.

The industry has long sought an offset printing process and associated materials that would not require a separate fountain solution. Waterless plates have been made by applying to the non-image area a silicone rubber, which has a very low surface energy and is not wetted by the ink. The silicone-modified plates are expensive, however, and require expensive, specially-cooled press equipment because the fountain solution of the traditional two-fluid method also serves as a coolant. Other efforts have been directed to producing a single-fluid lithographic ink, i.e., an ink that does not require a separate fountain solution, that can be used with the industry-standard presses and all-metal plates. Parkinson, in U.S. Pat. No. 4,045,232 (the entire disclosure of which is expressly incorporated herein by reference) describes lithographic printing and earlier efforts directed to producing a single-fluid lithographic ink and the tendency of single-fluid inks to be unstable. Parkinson notes that ink emulsions containing a solution of glycerin and salts tend to “break,” with the result that the glycerin wets the inking rollers preventing good inking. Parkinson suggests an improved single-fluid ink obtained by using an additive that includes a resin treated with a concentrated mineral acid, and, optionally, a polyhydric or monohydric alcohol. Preferred polyols are glycerin, ethylene glycol, and propylene glycol. DeSanto, Jr. et al, in U.S. Pat. No. 4,981,517 (the entire disclosure of which is expressly incorporated herein by reference) describe a printing ink that is an emulsion of an oil-based phase and a water-miscible phase. The patentees allege that an emulsion containing a significant portion of water (10% to 21%) and employing phosphoric acid as a critical component has improved stability against phase separation and can be used as a single-fluid lithographic ink. The De Santo, Jr. composition further includes as a diluent and emulsion stabilizer an oil with the properties of No. 1 and No. 2 fuel oils and a polyol emulsifier, of which glycerin and ethylene glycol are the only examples provided.

Nonetheless, due to various drawbacks of the single-fluid lithographic inks that have previously been proposed, including the limited stability and poor definition and toning already mentioned, the industry standard continued to be a dual-fluid lithographic ink that included an ink component in an ink fountain and a separate fountain solution component contained in a dampener.

Kingman et al., U.S. Pat. No. 6,140,392, issued Oct. 31, 2000 describes a single-fluid lithographic ink in which a polyol phase is dispersed or emulsified in a hydrophobic ink phase. The ink phase contains a carboxylic acid-functional vinyl polymer. The polyol phase includes at least a liquid polyol. The stability is such that the two phases do not separate in the fountain. During application of the ink, however, the emulsion breaks and the polyol comes to the surface, wetting out the areas of the plate that are not to receive ink. Inks that are stable in the fountain but break quickly to separate on the plate print cleanly without toning and provide consistent transfer characteristics.

Certain substrates or applications, however, are better suited to printing with inks having vehicle components different from vinyl copolymers. In order to achieve the best properties for these printed substrates or applications, it would be desirable to provide a single fluid lithographic ink containing vehicle components other than vinyl copolymers.

### SUMMARY OF THE INVENTION

The invention provides a single fluid lithographic printing ink composition that includes a hydrophobic continuous phase and an emulsified hydrophilic fluid phase. The hydrophobic phase comprises a nonlinear, condensation polymer or resin having from about 0.25 to about 1.5 meq/gram of groups capable of forming hydrogen bond interactions with the hydrophilic fluid phase, from about 1.0 to about 3.0 meq/gram of alicyclic and/or aromatic groups, and from about 0.3 to about 3.0 meq/gram of aliphatic hydrocarbon segments having from about 8 carbon atoms to about 54 carbon atoms. The hydrophilic fluid phase contains water and/or a liquid polyol.

“Condensation” polymers according to the invention include those obtained by step-reaction polymerization, as contrasted with “addition” polymers obtained by chain-reaction polymerization. Thus, “condensation” polymers include polymers produced by step-reaction, regardless of whether a by-product small molecule is produced, as classified by Flory and Billmeyer, Jr. See Fred W. Billmeyer, Jr., “Textbook of Polymer Science (3d ed. 1984), pages 25-26. “Polymer” as used herein refers to polymers, oligomers, and resins inclusively.

The branched polymer structure can be obtained from polymerization with one or more monomers having three or more reacting groups, or from reaction after polymerization with a material having a plurality of groups reactive with functional groups on the polymer. While the polymer is branched, it nonetheless remains usefully soluble in the hydrophobic phase. By contrast, polymers may be more extensively crosslinked into insoluble, three-dimensional network structures that can only be swelled by solvents and are thus not soluble in the hydrophobic phase.

The invention further provides a method of making an ink composition having a hydrophobic phase that includes the nonlinear polymer having groups that form hydrogen bond interactions with an emulsified hydrophilic phase. In another aspect of the invention, the printing ink is modified by the addition of another vehicle resin or polymer in the hydrophobic phase. The invention also provides a process of printing using the single fluid ink of the invention.

The invention has unexpectedly provided stable inks that can be used as single fluid inks with improved fountain stability and resistance to toning.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### DETAILED DESCRIPTION OF THE INVENTION

The invention provides a single fluid lithographic printing ink composition that includes a hydrophobic phase containing a nonlinear, hydrogen bonding condensation polymer and an emulsified hydrophilic fluid phase that contains water, a liquid polyol, or both water and a liquid polyol. The hydrophobic phase may contain further polymers and/or resins suitable for ink vehicles as well as pigments, while the hydrophilic fluid phase may contain additional materials as well as additives such as weak acids or weak bases to enhance the hydrogen bonding strength of the fluid. The lithographic ink compositions have a sufficient amount of hydrogen bonding between the hydrophobic phase and the hydrophilic phase so that the single fluid ink does not separate in the fountain and a sufficiently limited amount of hydrogen bonding between the hydrophobic phase and the hydrophilic phase so that during application of the ink the emulsion breaks and the water and/or polyol comes to the surface, wetting out the areas of the plate that are not to receive ink. Inks that are stable in the fountain but break quickly to separate on the plate print cleanly without toning and provide consistent transfer characteristics. Proper stability also may depend upon the particular hydrogen bonding polymer and the particular polyol, or water, chosen for the hydrophilic phase. The content of hydrogen bonding groups and molecular weight of the polymer and the amount of the hydrogen bonding polymer in the ink may be adjusted to provide the desired stability. In general, it is believed that an increase in hydrogen bonding groups on the condensation polymer should be accompanied by a decrease in the amount of such polymer included in the hydrophobic phase.

The nonlinear, hydrogen bonding condensation polymer is soluble in the hydrophobic phase. The term “nonlinear” refers to a polymer with one or more branches. The polymer is not crosslinked, but rather remains soluble in the continuous phase of the ink.

The hydrophilic fluid phase includes water, one or more liquid polyols, or both water and one or more liquid polyols. A liquid polyol is an organic liquid with at least two hydroxyl groups. Polyethylene glycol oligomers such as diethylene glycol, triethylene glycol, and tetraethylene glycol, as well as ethylene glycol, propylene glycol, 1,3-propanediol, dipropylene glycol, 1,4-butanediol, and glycerol are examples of liquid polyols that are preferred for the hydrophilic fluid phase of the single-fluid ink of the invention. The emulsified phase may, of course, include mixtures of different liquid polyols or a mixture of water and one or more liquid polyols. In general, higher molecular weight liquid polyols may be preferred when the condensation polymer of the hydrophobic phase has a higher equivalent weight with respect to the hydrogen bonding groups.

The emulsified phase may include further materials. In one embodiment, the emulsified phase may also include one or more solid polyols. The solid polyols may be selected from solid polyol compounds and solid polyol oligomers. Examples include, without limitation, 2,3-butanediol, 1,6-hexanediol and other hexanediols, pentaerythritol, dipentaerythritol, hydroxyl hyperbranched dendrimers, trimethylolethane, trimethylolpropane, neopentyl glycol, 2,2,4-trimethyl-1,3-pentanediol, 1,4-cyclohexanedimethanol, and hydrogenated bisphenol A. Compounds having one hydroxyl group and up to about 18 carbon atoms, preferably up to about 8 carbon atoms may also be included, such as cyclohexanol and stearyl alcohol. The emulsified phase may also include a weak acid such as citric acid, tartaric acid, or tannic acid, or a weak base such as triethanolamine, which may preferably be included in an amount of from about 0.01 weight percent up to about 2 weight percent of the ink composition. Certain salts such as magnesium nitrate may be included, preferably in amounts of from about 0.01 weight percent to about 0.5 weight percent, preferably from about 0.08 to about 1.5 weight percent, based on the weight of the ink composition, to help protect the plate and extend the life of the plate. A water soluble polymer, such as poly(vinyl pyrrolidone), poly(vinyl alcohol), and poly(ethylene glycol), may be added to the emulsified phase. Preferably from about 0.5 weight percent to about 1.5 weight percent of the water soluble polymer is included, based on the weight of the ink composition.

Lithographic, single-fluid inks may be formulated with from about 5% up to about 50%, preferably from about 10% to about 35%, and particularly preferably from about 20% to about 30% of the emulsified fluid phase by weight based on the total weight of the ink composition. Unless another means for cooling is provided, there is preferably a sufficient amount of emulsified fluid in the ink composition to keep the plate at a workably cool temperature, preferably at least about 5% by weight, more preferably at least about 10% by weight, and even more preferably at least about 15% by weight, and up to about 50% by weight, preferably up to about 35% by weight, and more preferably up to about 30% by weight. The amount of the emulsified fluid phase necessary to achieve good printing results without toning may depend upon the kind of plate being used and may be determined by straightforward testing.

The hydrophobic continuous phase stabilizes the emulsified fluid phase. The stability is such that the two phases do not separate in the fountain. During application of the ink, however, the emulsion breaks and the polyol comes to the surface, wetting out the areas of the plate that are not to receive ink. Destabilizing interactions, such as between an additional polymer, resin, or other material of the continuous phase and the condensation polymer of the emulsified fluid phase, is avoided. In general, additional materials that are more hydrophilic than the hydrogen-bonding condensation polymer are avoided in the continuous phase.

The hydrophobic phase of the single fluid ink includes at least a hydrogen-bonding condensation polymer or resin having, or mixture of condensation polymers or resins collectively having, from about 0.25 meq/gram to about 1.5 meq/gram, preferably from about 0.25 meq/gram to about 1.4 meq/gram, and more preferably from about 0.3 meq/gram to about 1.3 meq/gram of groups that form hydrogen bond interactions with the hydrophilic phase. Among preferred hydrogen bonding groups are carboxylic acid groups, carboxylic anhydride groups, primary amines or amines having alkyl substituents of three or fewer carbon atoms on the nitrogen atom, primary amides or amides having alkyl substituents of three or fewer carbons on the nitrogen atom, esters having pendent alkyl groups of three or fewer carbon atoms, β-hydroxyl esters, hydroxyls, acetoacetate groups, and sulfur-containing groups including sulfoxides, sulfones, and mercaptans, and urethane linkages, amide linkages, and ester linkages. Preferred among these are carboxylic acid groups, alcohols, amides, and combinations of these. It is preferred to add weakly basic materials to the hydrophilic fluid phase in order to strengthen the hydrogen bonding when an hydroxyl-functional condensation polymer is used.

Carboxyl-functional condensation polymers of the invention may be prepared by polymerization of a monomer mixture that includes at least one acid-functional monomer or at least one monomer that has a group that is converted to an acid group following polymerization, such as an anhydride group. Acid functionality may also be provided by other known means, such as by ring opening a cyclic anhydride with an hydroxyl group to form an ester linkage and a free acid group.

Examples of amines and amide groups include, without limitation, primary amides, N-alkylamides in which the N-alkyl group has three or fewer carbon atoms, N,N′-dialkylamides in which each N-alkyl group has three or fewer carbon atoms, primary amines, N-alkylamines in which the N-alkyl group has three or fewer carbon atoms, N,N′-dialkylamines in which the N-alkyl group has three or fewer carbon atoms, phosphonamides, and sulfonamides.

Examples of sulfur-containing groups include sulfonic acids, sulfonamides, sulfoxides, sulfones, and mercaptans. Examples of suitable phosphorous-containing groups include, without limitation, phosphoric acid groups, phosphates, and phosphonamides.

The hydrogen bonding condensation polymer or combination of condensation polymers of the invention may also contain a combination of the above functional groups capable of forming hydrogen bonding interactions. The hydrogen bonding group of the condensation polymer(s) may be a hydrogen donating species and/or a hydrogen accepting species. It will be appreciated that the condensation polymer or polymers and the hydrophilic fluid may have the same chemical functional group participating as both the donor species and the acceptor species of the hydrogen bond pair. For example, hydroxyl groups on the condensation polymer may interact with hydroxyl groups of the hydrophilic phase. By the same token, the donor and acceptor species may be different chemical groups. For example, an amide group may hydrogen bond with an hydroxyl group. In addition, some functional groups on the hydrogen bonding condensation polymer(s) may serve as acceptor species, others as donor species, and others as both. In general, the water and/or polyol(s) of the hydrophilic fluid phase can act both as acceptors and donors.

The strength of a hydrogen bond is related to the relative acidity and basicity of the donor and acceptor species. If it is desired to strengthen the hydrogen bond formed between a donor with a weakly acidic hydrogen atom and an acceptor, it is possible to add acidic materials to the donor species to increase its hydrogen bonding affinity. Alternatively, a weakly basic material may be added to a hydrogen acceptor to increase the strength of a hydrogen bond. In some situations, ionic interaction may be moderated and controlled by appropriate additions of weak acids and weak basis to the donor and acceptors.

The hydrogen bonding polymer or mixture of polymers also has from about 1.0 to about 3.0 meq/gram, preferably from about 1.1 to about 2.8 meq/gram, and more preferably from about 1.1 to about 2.5 meq/gram of aromatic and/or alicyclic groups. The aromatic groups are preferably six-membered rings, although a minor amount of fused rings or conjugated linear segments may be included. The alicyclic groups may be selected from rings having from about three- to about six-membered rings, including heterocyclic rings. Examples of suitable monomer compounds that may be incorporated to provide aromatic groups include, without limitation, benzoic acid; biphenyl carboxylic acid; phthalic anhydride, isophthalic acid, terephthalic acid; phenol; phenolic compounds including tert-butyl phenol, octylphenol, nonylphenol, dinonylphenol, isopropyl phenol, amylphenol, diphenylolpropane, phenylphenol, resorcinol, cashew nut liquid, cumylphenol, cresols (including ortho-, meta-, and para-cresols), 1,3,5-xylenols, bisphenol A, bisphenol F; alkoxylated phenolic compounds such as ethoxylated bisphenol A materials; novolac resins, particularly those with three or four aromatic rings; the epoxide-functional ethers of any of the phenolic or alkoxylated phenolic materials; higher molecular weight epoxy resins based on bisphenol A with degrees of polymerization of from 2 to about 30; epoxy phenol novolac resins and epoxy cresol novolac resins, particularly those with three or four aromatic rings; resoles; phenolic modified rosin esters; and combinations of these. Examples of suitable monomers that may be incorporated to provide alicyclic groups include, without limitation, dimer fatty acid, trimer fatty acid, dimer fatty alcohol, trimer fatty alcohol, alicyclic epoxide-functional compounds, and the like. The meq/gram of aromatic and/or alicyclic groups may be calculated by adding the milliequivalents per gram of reactants having such groups, wherein such milliequivalents per gram is determined my multiplying the millimoles per gram of the reactant by the number of aromatic and alicyclic groups per molecule of the reactant.

The polymer or the mixture of polymers also has from about 0.3 to about 3.0 meq/gram, preferably from about 0.35 to about 2.8 meq/gram, and more preferably from about 0.35 to about 2.5 meq/gram of one or more aliphatic hydrocarbon segments having from about 8 carbon atoms to about 51 carbon atoms directly bonded in carbon-carbon bonds, especially segments having 33 or 51 carbon atoms. In considering the number of carbon atoms of the aliphatic carbon-carbon segments, the end carbons having functionality (for example, the carbonyl carbon of carboxylic acid or ester functionality, or the carbon of C—O ether, ester or alcohol functionality) are excluded. It is particularly preferred to have such segments in the polymer backbone. Examples of suitable monomer compounds that can be incorporated into the polymer to provide the carbon—carbon segments include, without limitation, dimer fatty acid, trimer fatty acid, and their corresponding alcohols; fatty acids and alcohols having from 9 to 18 carbons, including pelargonic acid, lauric acid, lauryl alcohol, tall oil fatty acid, linseed oil, linoleic acid, oleic acid, and stearic acid; and combinations of these. The meq/gram of the aliphatic hydrocarbon segments may be calculated by adding the milliequivalents per gram of reactants having such groups, wherein such milliequivalents per gram is determined my multiplying the millimoles per gram of the reactant by the number of the aliphatic hydrocarbon segments per molecule of the reactant.

In a preferred embodiment, the hydrogen-bonding condensation polymers or resins have from about 0.2 to about 3.5 meq/gram of branch points, more preferably from about 0.25 to about 2.0 meq/gram of branch points, and even more preferably from about 0.25 to about 1.4 branch points. When branched, the polymer used in the inks of the invention is usefully soluble. The branched polymers of the invention may be diluted, rather than swollen, by addition of solvent and are dissolved in the hydrophobic phase. The branching may result from reaction of a monomer with three or more groups that participate in the condensation reaction. The groups need not all be the same. For example, and without limitation, a monomer may have two alcohol groups and an acid group (a specific example may be dimethylolpropionic acid), with the two alcohol groups reacting, for example, with anhydride, carboxylic acid, or isocyanate groups of comonomers and the acid group reacting with alcohol groups on other molecules of the same monomer or with alcohol or epoxide groups of comonomers. Branching may also be achieved by reacting pendant groups on the polymer, either with each other or with a crosslinking compound having two or more groups reactive with the pendant groups.

Specific examples of materials that may be included in the condensation polymer or resin portion or reacted into the condensation polymer or resin to provide branching include, without limitation, fumarated or maleated rosin acid, rosin phenolic resole addition product, fumarated or maleated rosin phenolic resole addition product, other polycarboxylic acids or anhydrides such as trimer fatty acid and trimellitic anhydride; polyols such as trimethylolpropane and pentaerythritol; epoxies having three or more epoxide groups; trifunctional isocyanates such as biurets, isocyanurates, and allophanates of diisocyanates and triisocyanates such as 4-isocyanatomethyl-1,8-octamethylene diisocyanate and 4,4′,4″-triphenylmethane triisocyanate, 1,3,5-benzene triisocyanate and 2,4,6-toluene triisocyanate; compounds having three or more amine groups or a combination of amine groups and other groups that total at least three reactive groups, such as trifunctional amino acids and amino alcohols; and combinations of these. The meq/gram of branch points may be calculated by adding the millimoles per gram of reactants having three or more reactive groups per molecule, regardless of how many reactive groups the reactant has in excess of two.

The polymers of the invention may also be crosslinked by subjecting the polymer to reaction with a crosslinker after polymerization. Such crosslinkers include at least two functional groups reactive with functional groups on the polymer. That is, the crosslinker and the polymer contain mutually reactive groups. A variety of such pairs of mutually reactive groups are possible. Illustrative examples of such pairs of reactive groups include, without limitation, epoxide and carboxyl groups, amine and carboxyl groups, epoxide and amine groups, epoxide and anhydride groups, amine and anhydride groups, hydroxyl and carboxyl or anhydride groups, amine and acid chloride groups, alkylene-imine and carboxyl groups, organoalkoxysilane and carboxyl groups, isocyanate and hydroxyl groups, cyclic carbonate and amine groups, isocyanate and amine groups, and so on. The amount of crosslinking is limited so that the condensation polymer remains soluble in the continuous phase. The meq/gram of branch points may be calculated by adding the millimoles per gram of reactants having three or more reactive groups per molecule, regardless of how many reactive groups the reactant has in excess of two, from the polymer if any, and the millimoles per gram of crosslinker with three or more reactive groups (regardless of how many reactive groups above three the crosslinker has) used to crosslink the polymer.

The reactive groups on the crosslinker may be the same or different, and the crosslinker will be selected according to what functional groups are present on the polymer. If the crosslinking involves reaction of the hydrogen bonding groups on the polymer, then the hydrogen bonding groups should be in sufficient excess so that after such crosslinking there are still available hydrogen bonding groups to form hydrogen bonds with components of polyol phase. Examples of crosslinkers include, without limitation, polycarboxylic acids, polyamines, polyisocyanates, polyepoxides, and polyhydroxyl containing species. Non-limiting examples of crosslinkers include diethylene glycol, triethylene glycol, hexanediamine, adipic acid, neopentyl glycol, dipropylene glycol, tripropylene glycol, 1,4-cyclohexanedimethanol, 1,6-hexanediol, 1,3-butanediol, hydrogenated bisphenol A, 2,2,4-trimethyl-1,3-pentanediol, diepoxide esters, aluminum gellants, and combinations of these.

In a preferred embodiment, aluminum gellants are used as the external crosslinker. Such aluminum gellants may be aluminum salts, aluminum organic complexes, aluminum alkoxides. The aluminum gellants crosslink the functionalized condensation polymer by forming aluminum alkoxide bridges between reactive groups on the polymer. Specific examples of aluminum gellants useful in the invention include, without limitation, aluminum ethyl acetoacetonate, aluminum 2-propoxide ethyl acetate, aluminum sec-butoxide ethyl acetoacetate, aluminum triisopropoxide, aluminum tris-sec-butoxide, aluminum diisopropoxide aceto ester, aluminum oxyacylate (OAO from Chattem Chemicals), aluminum 2-ethylhexanoate, aluminum isopropyl 2-ethylhexanoate, polymeric aluminum 2-ethylhexanoate, and combinations of these. In addition, alkoxylated titanates and zirconates may be used, for example, without limitation, di(cumyl)phenyl oxoethylene titanate, di(dioctyl) phosphato ethylene titanate, diisopropyl distearoyl titanate, the corresponding zirconates, and combinations of these. Combinations of aluminum gellants, alkoxylated titanates, and alkoxylated zirconates are also useful.

In one embodiment, the hydrophobic phase includes one or more resins selected from rosin phenolic resoles, addition products of rosin phenolic resoles with unsaturated acids, and esters and partial esters of these, preferably with polyols, especially glycerol or pentaerythritol; rosin esters of polyols, including ethylene glycol, oligomers of ethylene glycol (diethylene glycol, triethylene glycol, etc.), glycerol, pentaerythritol, and trimethylolpropane; addition products of rosin and unsaturated acids (e.g., maleic, fumaric, acrylic acids) and esters and partial esters of these with the polyols already mentioned; phenol formaldehyde condensation products, including resoles, condensation products of phenol formaldehyde and rosins including rosin phenolic resoles, addition products of these with unsaturated acids and esters of these, particularly with polyols; condensation products of polyepoxides an rosins or of the modified rosin materials already mentioned.

The polymerization is usually carried out neat or in solution, typically at temperatures from about 80° C. to about 300° C. Specific reaction conditions depend upon the monomers chosen. A rosin phenolic resole, for example, may be made by reacting phenol or a substituted phenol with paraformaldehyde using magnesium oxide as a catalyst at a temperature of from 125° C. to about 150° C. for about two to five hours at atmospheric pressure or in about one to two hours in a closed reactor building to a pressure of from about 25 to 100 psi. The phenolic resole reaction product may be concurrently or sequentially reacted with rosin or an addition product of rosin with an unsaturated compound, e.g. fumarated or maleated rosin, at a temperature of about 185° C. to about 200° C. for about two hours. A fumarated or maleated rosin or fumarated or maleated rosin phenolic resole may be made by the Diels-Alder addition of maleic anhydride or fumaric acid to the abietic or levopimaric acid of rosin, rosin-containing tall oil fatty acid, or phenolic resole reaction product at a temperature from about 150° C. to about 250° C. rosin. Acid groups of the product may be esterified with a multifunctional alcohol such as pentaerythritol at a temperature from about 200° C. to about 300° C., optionally using an esterification catalyst such as a mixture of magnesium oxide and dibutyl tin laurate, with the reaction continuing for six to ten hours or until the acid number on the resin is less than perhaps 25 mg KOH/g resin. The esterification reaction between the acid-functional intermediates and an alicyclic epoxide may be carried out at a temperature from about 200° C. to about 280° C. for two to six hours or until the acid number on the resin is less than perhaps 25 mg KOH/g resin. A polyester may be formed from the esterification reaction of fatty acid, dimer fatty acid, trimer fatty acid, biphenyl carboxylic acid, and benzoic acid in mixtures that include at least some of the polycarboxylic acid(s) with a polyol or polyol mixture including at least one polyol having more than two hydroxyl groups, for example pentaerythritol, carried out at a temperature from about 150° C. to about 250° C.

A branching reaction, if it is not carried out simultaneously with polymerization, can usually be carried out under similar conditions, with or without an appropriate catalyst.

Additional resins or polymers may be used, for example, to disperse and stabilize pigment against flocculation. Any additional resin or pigment included is selected so as not to interfere with hydrogen bonding between the branched, condensation polymer and the emulsified phase in the single fluid lithographic ink. For example, the additional resin or polymer should be less hydrophilic than the branched, condensation polymer so that it does not interfere with the interaction between the hydrogen-bonding, aromatic polymer and the emulsified hydrophilic fluid phase. The additional resin(s) or polymer(s) are preferably dissolved in the continuous phase.

The continuous phase of the ink composition of the invention preferably includes one or more hydrocarbon solvents. The particular solvents and amount of solvent included is determined by the ink viscosity, body, and tack desired. In general, non-oxygenated solvents or solvents with low Kauri-butanol (KB) values are used for inks that will he in contact with rubber parts such as rubber rollers during the lithographic process, to avoid affecting the rubber. Suitable solvents for inks that will contact rubber parts include, without limitation, aliphatic hydrocarbons such as petroleum distillate fractions and normal and isoparaffinic solvents with limited aromatic character. For example, petroleum middle distillate fractions such as those available under the trade name Magiesol, available from Magie Bros. Oil Company, a subsidiary of Pennsylvania Refining Company, Franklin Park, Ill., under the trade name ExxPrint, available from Exxon Chemical Co., Houston, Tex., and from Golden Bear Oil Specialties, Oildale, Calif., Total Petroleum Inc., Denver, Colo., and Calumet Lubricants Co., Indianapolis, Ind. may be used. In addition or alternatively, soybean oil or other vegetable oils may be included.

Preferably, the solvent or solvent mixture will have a boiling point of at least about 100° C. and preferably not more than about 550° C. Offset printing inks may use solvents with boiling points above about 200° C. News inks usually are formulated using from about 20 to about 85 percent by weight of solvents such as mineral oils, vegetable oils, and high boiling petroleum distillates in the hydrophobic phase. The amount of solvent also varies according to the type of ink composition (that is, whether the ink is for newsprint, heatset, sheetfed, etc.), the specific solvents used, and other factors known in the art. Typically the solvent content for lithographic inks is up to about 60% by weight of the hydrophobic continuous phase, which may include oils as part of the solvent package. Usually, at least about 35% by weight solvent is present in the continuous phase of the lithographic ink.

The ink compositions of the invention will usually include one or more pigments. The number and kinds of pigments will depend upon the kind of ink being formulated. News ink compositions typically will include only one or only a few pigments, such as carbon black. Lithographic printing inks are typically used in four colors—magenta, yellow, black, and cyan, and may be formulated for pearlescence or metallic effect. Any of the customary inorganic and organic pigments may be used in the ink compositions of the present invention. Alternatively, the compositions of the invention may be used as overprint lacquers or varnishes. The overprint lacquers (air drying) or varnishes (curing) are intended to be clear or transparent and thus opaque pigments are not included.

It will be appreciated by the skilled artisan that other additives known in the art that may be included in the ink compositions of the invention, so long as such additives do not significantly detract from the benefits of the present invention. Illustrative examples of these include, without limitation, pour point depressants, surfactants, wetting agents, waxes, emulsifying agents and dispersing agents, defoamers, antioxidants, UV absorbers, dryers (e.g., for formulations containing vegetable oils), flow agents and other rheology modifiers, gloss enhancers, and anti-settling agents. When included, additives are typically included in amounts of at least about 0.001% of the ink composition, and may be included in amounts of about 7% by weight or more of the ink composition, depending upon their nature.

The compositions of the invention are particularly suited for use in lithographic applications, including, without limitation, as heatset inks, news inks, and sheetfed inks. Offset printing processes in which the inks of the invention may be used are well-known in the art and are described in many publications. Because the ink of the invention is a single fluid lithographic ink, no dampener or separate fluid is used. The emulsified fluid phase is the fluid during printing.

The invention is illustrated by the following examples. The examples are merely illustrative and do not in any way limit the scope of the invention as described and claimed. All parts are parts by weight unless otherwise noted.

### EXAMPLES

### Example 1

### Preparation of a Branched Polymer of the Invention with Carboxyl and Hydroxyl Groups

A one-liter glass reactor equipped with stirrer and nitrogen inlet was charged with 41.7 parts by weight of tall oil rosin (Pamite 79 obtained from Hercules, Incorporated, Franklin, Va.). The rosin was heated to 200° C. with stirring under a blanket of nitrogen. After the rosin melted, 3 parts by weight of fumaric acid and 22.7 parts by weight of tall oil fatty acid were charged to the reactor. The temperature was held at 200° C. for 4 hours. The temperature was then set at 230° C. and 32.62 parts by weight of alicyclic epoxy ERL-4221 (obtained from Dow Chemical Company, Midland, Mich.) was added to the reactor. The temperature was held at 230° C. until the acid number on the resin was less than 25 mg KOH/g resin, then the reaction mixture was cooled to 150° C. and reduced to 55% by weight non-volailes with Exxprint 274A aliphatic ink solvent (available from Exxon-Mobil). The temperature was held at 150° C. for 30 minutes longer until the mixture was homogenous. The product was adjusted to the target viscosity of about 70 stokes at 130° C. with Exxprint 283D solvent (available from Exxon-Mobil).

The product polymer contained 2.4 meq/g alicyclic groups (from 1.29 mmoles/g alicyclic epoxy ERL-4221 times 1.88 equivalents alicyclic groups per molecule), 1.29 meq/g aliphatic hydrocarbon segments having from about 8 carbon atoms to about 51 carbon atoms, 0.26 meq/g of branch points (from 0.26 mmoles/g of product from the reaction of fumaric acid with rosin), and 0.93 meq/g of hydrogen bonding groups for hydrogen bonding with the hydrophilic phase of a single fluid ink (combined unreacted acid equivalents of acid and hydroxyl from the epoxide reaction).

### Example 2

### Preparation of a Solution of a Branched, Aromatic, Hydrogen Bonding Resin with Hydroxyl Groups

To a one-liter glass reactor equipped with stirrer and nitrogen inlet were charged 54 parts by weight of a fumarated rosin phenolic pentaerythritol resin (RP-341, available from Westvaco Corp, Charleston Heights, S.C.) and 46 parts by weight of aliphatic ink solvent, Exxprint 274A (available from Exxon-Mobil). The mixture was heated to 175° C. with stirring under a blanket of nitrogen. The temperature was held at 175° C. for 30 minutes or until the mixture was homogenous and adjusted to a target viscosity of 65-75 stokes at 130° F. with Exxprint 283D solvent (available from Exxon-Mobil).

The polymer is believed to contain 2.37 meq/g aromatic groups, 0.39 meq/g aliphatic hydrocarbon segments having from about 8 carbon atoms to about 51 carbon atoms, 1.15 meq/g of branch points, and 0.34 meq/g of hydrogen bonding groups for hydrogen bonding with the hydrophilic phase of a single fluid ink.

### Example 3

### Preparation of a Solution of an Aromatic, Hydrogen Bonding Resin with Carboxyl and Hydroxyl Groups

To a one liter reaction kettle equipped with double paddle stirrer, nitrogen inlet, thermocouple, and Dean-Stark condenser were charged 83.7 grams of pentaerythritol, 75.1 grams of benzoic acid, 172.3 grams of tall oil fatty acid. The mixture was heated to reflux temperature with a catalytic quantity of calcium hydroxide and dibutyl tin dilaurate, under a nitrogen atmosphere, using an azeotrope of xylene (4% w/w on batch) to facilitate the removal of the water by-product. After an acid number of <20 mg KOH/g resin was achieved, the reaction mixture was cooled slightly and 81.4 grams of ethoxylated bisphenol A polyol (Synfac 8022, available from Milliken & Company), 196.3 grams of trimer fatty acid (Empol 1043, available from Cognis), and 142.5 grams of dimer fatty acid (Empol 1062, available from Cognis) were added. The reaction mixture was refluxed further until an acid number of about 20 mg KOH/g resin was attained. The mixture was cooled and filtered of any gel particles to yield a viscous brown resin. The resin was then dissolved in 322.5 grams of Exxprint 274A (available from ExxonMobil Corporation)

The product polymer contained 1.14 meq/g aromatic groups (from 0.8133 mmoles/g benzoic acid and 0.3265 mmoles/g Synfac 8022), 1.5 meq/g aliphatic hydrocarbon segments having from about 8 carbon atoms to about 51 carbon atoms (from 0.8146 mmoles/g of tall oil fatty acid, 0.35 mmoles/g of Empol 1043, and 0.337 mmoles/g of Empol 1062), 1.14 meq/g of branch points (from 0.35 mmoles/g of Empol 1043 and 0.7949 mmoles/g of pentaerythritol), and 1.28 meq/g of hydrogen bonding groups for hydrogen bonding with the hydrophilic phase of a single fluid ink (AN=20 represents 20/56.11 meq/g unreacted acid=0.3564 meq/g unreacted acid; excess OH=(3.1794 meq OH/g from pentaerythritol+0.6531 meq OH/g from Synfac 8022 (0.6741 meq acid/g from Empol 1062+0.9587 meq acid/g from Empol 1062+0.8146 meq acid/g from tall oil fatty acid+0.8133 meq acid/g from benzoic acid−0.3564 meq/g unreacted acid)).

### Example 4

### Preparation of Single Fluid Ink

Mixture 4a was formed by mixing in a glass beaker until homogenous 80 parts by weight of diethylene glycol, 18 parts by weight of ethylene glycol, 1 part by weight of deionized water, 0.5 part by weight of citric acid, and 0.5 parts by weight of magnesium nitrate.

Using a high speed mixer, 20 parts by weight of a hydrocarbon resin solution (60% LX-2600 in ExxPrint 283D, available from Neville) was mixed with 25 parts by weight of magenta flush 57FQ309 (available from CDR Corporation, Elizabethtown, Ky.) and 5 parts by weight of alkyl refined linseed oil for about 20 minutes. Then, 20 parts by weight of the hydrogen bonding resin solution of Example 1 and 2 parts by weight of additives (Teflon wax, drier) were added and mixed at a high speed for 30 minutes at 160° F. to form a mixture 4b.

To make the ink, the mixture 10a is mixed with the mixture 10b.

The invention has been described in detail with reference to preferred embodiments thereof. It should be understood, however, that variations and modifications can be made within the spirit and scope of the invention and of the following claims.

What is claimed is:

1. A lithographic ink composition, comprising
a continuous hydrophobic phase and an emulsified hydrophilic phase,
wherein the continuous hydrophobic phase comprises a dissolved condensation polymer having from about 0.25 to about 1.5 meq/gram of groups capable of hydrogen bonding with the hydrophilic phase, from about 1.0 to about 3.0 meq/gram of one or more members selected from the group consisting of aromatic groups, cyclic aliphatic groups, and combinations thereof, and from about 0.3 to about 3.0 meq/gram of aliphatic hydrocarbon segments, each independently having from about 8 carbon atoms to about 51 carbon atoms, and
further wherein the emulsified phase comprises at least one member selected from the group consisting of water, liquid polyols, and combinations thereof.

2. A lithographic ink composition according to claim 1, wherein the condensation polymer has from about 0.2 to about 3.5 meq/gram of branch points; and

3. A lithographic ink composition, comprising
a continuous hydrophobic phase and an emulsified hydrophilic phase,
wherein the continuous hydrophobic phase comprises a mixture of dissolved condensation polymers that together comprise from about 0.25 to about 1.5 meq/gram of groups capable of hydrogen bonding with the hydrophilic phase, from about 1.0 to about 3.0 meq/gram of one or more members selected from the group consisting of aromatic groups, cyclic aliphatic groups, and combinations thereof, and from about 0.3 to about 3.0 meq/gram of aliphatic hydrocarbon segments, each independently having from about 8 carbon atoms to about 51 carbon atoms; and
further wherein the emulsified phase comprises at least one member selected from the group consisting of water, liquid polyols, and combinations thereof.

4. A lithographic ink composition according to claim 3, wherein the mixture of condensation polymers together comprise from about 0.2 to about 3.5 meq/gram of branch points; and

5. A lithographic ink composition according to claim 1 or claim 3, wherein the emulsified phase comprises a liquid polyol selected from the group consisting of ethylene glycol, diethylene glycol, triethylene glycol, tetraethylene glycol, propylene glycol, dipropylene glycol, 1,3-propanediol, 1,4-butanediol, and mixtures thereof.

6. A lithographic ink composition according to claim 1 or claim 3, wherein the ink composition includes from about 5% to about 50% of the emulsified phase by weight.

7. A lithographic ink composition according to claim 1 or claim 3, wherein the emulsified phase includes a weak acid or a weak base.

8. A lithographic ink composition according to claim 1 or claim 3, wherein the emulsified phase includes magnesium nitrate.

9. A lithographic ink composition according to claim 1 or claim 3, wherein the emulsified phase is nonaqueous.

10. A lithographic ink composition according to claim 1 or claim 3, wherein the hydrophobic phase includes at least one additional resin or polymer.

11. A lithographic ink composition according to claim 1 or claim 3, wherein the emulsified phase includes a further material that increases hydrogen bonding between the emulsified phase and the hydrophobic phase.

12. A lithographic ink composition according to claim 1 or claim 3, wherein the emulsified phase further comprises at least one member selected from the group consisting of solid polyols, compounds having one hydroxyl group and up to 18 carbon atoms, and combinations thereof.

13. A lithographic ink composition according to claim 1 or claim 3, wherein the emulsified phase further comprises a water soluble polymer.

14. A lithographic ink composition according to claim 1 or claim 3, wherein the groups capable of hydrogen bonding with the hydrophilic phase are selected from the group consisting of carboxylic acid groups, carboxylic anhydride groups, primary amines, amines having alkyl substituents of three or fewer carbon atoms on the nitrogen atom, primary amides, amides having alkyl substituents of three or fewer carbons on the nitrogen atoms, esters having pendent alkyl groups of three or fewer carbons, β-hydroxyl esters, hydroxyl groups, acetoacetate groups, sulfur-containing groups, urethanes linkages, and combinations thereof.

15. A lithographic ink composition according to claim 1, wherein the condensation polymer is a member selected from the group consisting of addition products of rosins and unsaturated acids, rosin phenolic resoles, addition products of rosin phenolic resoles and unsaturated acids and esters and partial esters thereof.

16. A lithographic ink composition according to claim 3, wherein the hydrophobic phase comprises at least one member selected from the group consisting of rosin phenolic resoles, addition products of rosin phenolic resoles with unsaturated acids, rosins, addition products of rosins and unsaturated acids, phenol formaldehyde condensation products, condensation products of phenol formaldehyde and rosins, addition products with unsaturated acids of condensation products of phenol formaldehyde and rosins, condensation products thereof with polyepoxides and condensations products thereof with polyols.

17. A method of making a lithographic printing ink, comprising a step of combining a first composition comprising dissolved condensation polymer having from about 0.25 to about 1.5 meq/gram of groups capable of hydrogen bonding with a second composition, from about 1.0 to about 3.0 meq/gram of one or more members selected from the group consisting of aromatic groups, cyclic aliphatic groups, and combinations thereof, and from about 0.3 to about 3.0 meq/gram of aliphatic hydrocarbon segments, each independently having from about 8 carbon atoms to about 51 carbon atoms; and a second composition comprising at least one member selected from the group consisting of water, liquid polyols, and combinations thereof, whereby a printing ink is formed having as a continuous phase the first composition and as an emulsified phase the second composition.

18. A method according to claim 17, wherein the condensation polymer further has from about 0.2 to about 3.5 meq/gram of branch points.

19. A lithographic ink composition according to claim 1 or claim 3, wherein the emulsified phase comprises water.

20. A lithographic ink composition according to claim 1 or claim 3, wherein the emulsified phase further comprises a member selected from the group consisting of solid polyol compounds, solid polyol oligomers, and compounds having one hydroxyl group and up to about 18 carbon atoms.

21. A lithographic ink composition according to claim 1 or claim 3, wherein the emulsified phase comprises water and a liquid polyol is selected from the group consisting of ethylene glycol, diethylene glycol, triethylene glycol, tetraethylene glycol, propylene glycol, dipropylene glycol, and mixtures thereof.

22. A printing method, comprising a step of printing a substrate by lithographic printing using as a single fluid lithographic ink the ink according to claim 1 or claim 3.

23. A lithographic ink composition, comprising
a continuous hydrophobic phase comprising a dissolved, branched condensation polymer or resin and
an emulsified hydrophilic phase comprising at least one member selected from the group consisting of water, liquid polyols, and combinations thereof;
wherein there is a sufficient amount of hydrogen bonding between the condensation polymer or resin and the hydrophilic phase so that the ink has fountain stability, and
further wherein there is a sufficiently limited amount of hydrogen bonding between the condensation polymer or resin and the hydrophilic phase so that during printing the ink is separated on the printing plate.
